(19) United States
(12) Patent Application Publication
(10) Pub. No.: US 2023/0274586 A1
(43) Pub. Date: Aug. 31, 2023

(54) ON-VEHICLE DEVICE, MANAGEMENT SYSTEM, AND UPLOAD METHOD

(71) Applicant: DENSO TEN Limited, Kobe-shi (JP)

(72) Inventor: Hideaki Miyazaki, Kobe (JP)

(73) Assignee: DENSO TEN Limited, Kobe-shi (JP)

(21) Appl. No.: 18/173,383

(22) Filed: Feb. 23, 2023

(30) Foreign Application Priority Data
Feb. 28, 2022 (JP) 2022-029597

(51) Int. Cl. G07C 5/00; G07C 5/08

(52) U.S. Cl. CPC G07C 5/008; G07C 5/0866

(57) ABSTRACT

An on-vehicle device includes a processor that acquires vehicle information that includes running information concerning a running state of a vehicle and image information that is captured by the vehicle, creates light information with a less amount of data from the acquired vehicle information and uploads it to an external device with a predetermined period, and uploads the requested vehicle information to the external device in a case where a request is provided from the external device.

### CROSS-REFERENCE TO RELATED APPLICATION(S)

This application is based upon and claims the benefit of priority to Japanese Patent Application No. 2022-029597, filed on Feb. 28, 2022, the entire contents of which are herein incorporated by reference.

### FIELD

A disclosed embodiment(s) relate(s) to an on-vehicle device, a management system, and an upload method.

### BACKGROUND

A management system has conventionally been provided that uploads an video that is captured by a dashboard camera that is mounted on a vehicle to a server device. For example, such a management system transmits an uploaded video to a preliminarily set address in a server device in a case where a shock is detected by a dashboard camera (see, for example, Japanese Laid-open Patent Publication No. 2010-108351)

However, a conventional technique has to upload all videos to a server device temporarily and has room for improvement in reducing an amount of data that are uploaded.

### SUMMARY

An on-vehicle device according to an aspect of an embodiment includes a processor that acquires vehicle information that includes running information concerning a running state of a vehicle and image information that is captured by the vehicle, creates light information with a less amount of data from the acquired vehicle information and uploads it to an external device with a predetermined period, and uploads the requested vehicle information to the external device in a case where a request is provided from the external device.

### BRIEF DESCRIPTION OF DRAWING(S)

FIG. 1 is a diagram that illustrates an outline of a management system.

FIG. 2 is a diagram that illustrates an outline of an upload method.

FIG. 3 is a block diagram of an on-vehicle device.

FIG. 4 is a block diagram of a management device.

FIG. 5 is a diagram that illustrates an example of learning data database.

FIG. 6 is a flowchart that illustrates a process procedure that is executed by an on-vehicle device.

FIG. 7 is a flowchart that illustrates a process procedure that is executed by a management device.

### DESCRIPTION OF EMBODIMENT(S)

Hereinafter, an embodiment(s) of an on-vehicle device, a management system, and an upload method as disclosed in the present application will be explained in detail with reference to the accompanying drawing(s). Additionally, the present invention is not limited by an embodiment(s) as illustrated below.

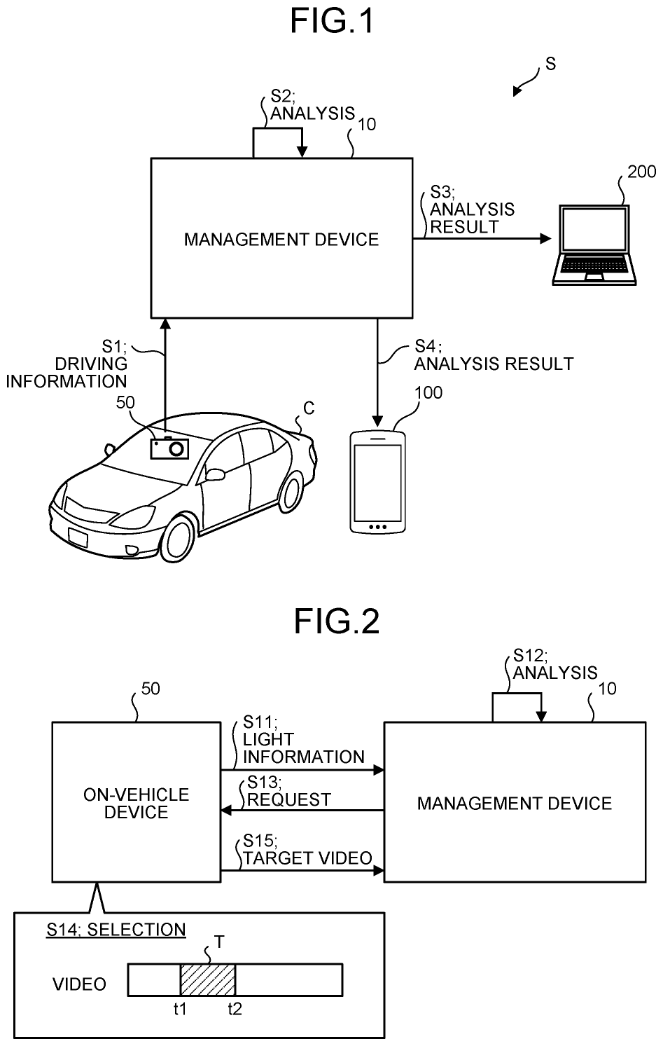

First, an outline of an on-vehicle device, a management system, and an upload method according to an embodiment will be explained by using FIG. 1 and FIG. 2. FIG. 1 is a diagram that illustrates an outline of a management system. FIG. 2 is a diagram that illustrates an outline of an upload method.

As illustrated in FIG. 1, a management system S according to an embodiment is, for example, a system that executes various types of evaluations concerning driving such as safe driving and/or eco-driving of a driver. Furthermore, for example, the management system S is introduced into a delivery company that provides a delivery vehicle such as a taxi and/or a truck, as well as a business operator that has a business vehicle.

As illustrated in FIG. 1, the management system S according to an embodiment includes a management device 10 and an on-vehicle device 50. The on-vehicle device 50 is, for example, a dashboard camera with a communication function.

The on-vehicle device 50 uploads vehicle information that includes running information concerning a running state of a vehicle C and image information that is captured by such a vehicle C to the management device 10. Additionally, although image information is, for example, information concerning a captured image of a front side of a vehicle C, it may be information concerning a captured image of a periphery of such a vehicle C and/or an inside (for example, a driver seat) of such a vehicle C.

Furthermore, driving information is, for example, information that is detected by various types of sensors that are provided to a vehicle C. For example, driving information includes positional information, vehicle speed information, acceleration information, steering information, etc., of a vehicle C, in addition to image information as described above.

The management device 10 analyzes vehicle information that is acquired from each on-vehicle device 50 so as to evaluate a current situation of each vehicle C and/or driving of a driver. Additionally, for example, the management device 10 is configured as a cloud server that provides a cloud service through a network such as the Internet and/or a mobile phone line network.

Furthermore, as illustrated in FIG. 1, the management device 10 is connected to a driver terminal 100 and/or a manager terminal 200 through a network. The driver terminal 100 is a terminal that is possessed by a driver of each vehicle C and is a smartphone in an example as illustrated in FIG. 1.

The manager terminal 200 is a terminal that is possessed by a manager that manages a driving situation, etc., of each vehicle C, and is a notebook Personal Computer (PC) in an example as illustrated in FIG. 1. For example, the manager terminal 200 displays information that is notified of from the management device 10 so as to notify a manager of a current situation of each vehicle C, an evaluation result for each driver, etc.

Herein, an outline of information processing according to an embodiment will be explained by using FIG. 1. For example, the management device 10 acquires driving information from the on-vehicle device 50 with a predetermined period (step S1) and analyzes acquired driving information (step S2). For example, the management device 10 executes evaluation of a current situation of each vehicle C, driving of a driver, etc., based on each driving information.

Subsequently, the management device 10 notifies the manager terminal 200 of an evaluation result concerning a current situation of each vehicle C (for example, a current place and/or a running route of a vehicle C) and/or a driving evaluation (step S3).

For example, the management device 10 executes processes at such steps S1 to S3 periodically and notifies the driver terminal 100 of an analysis result (for example, a result of a driving evaluation) at any timing, for example, at a time of close of business, etc. (step S4).

In such a management system S, for example, as each on-vehicle device 50 uploads all videos to the management device 10, it is not preferable from a viewpoint of communication traffic, a communication fee, etc. Hence, in an upload method according to an embodiment, the on-vehicle device 50 uploads lightened data such as a still image temporarily, and uploads requested data to the management device 10 in a case where a request is provided from the management device 10.

Specifically, as illustrated in FIG. 2, in an upload method according to an embodiment, the on-vehicle device 50 creates light information and uploads created light information to the management device 10 (step S11). Herein, light information is information where an amount of data of vehicle information that includes running information and image information is lightened.

More specifically, light information is information where image information in vehicle information is lightened, and is a still image that is captured with any period (for example, a one minute interval). That is, in an upload method according to an embodiment, a video is replaced with a still image when it is uploaded, so that reduction of an amount of data that are uploaded is attained.

The management device 10 analyzes light information that is uploaded from the on-vehicle device 50 (step S12), and requests the on-vehicle device 50 to upload detailed information in a case where such detailed information is needed (step S13). Additionally, analysis at step S12 may be executed by, for example, viewing, etc., of a manager that operates the manager terminal 200, so that such a manager may set information that is uploaded, to the on-vehicle device 50.

The on-vehicle device 50 selects requested information based on a request from the management device 10 (step S14). For example, as illustrated in FIG. 2, the on-vehicle device 50 selects a target video T within a specified time period and uploads a selected target video T to the management device 10 (step S15). Additionally, a target video may be a video of an outside of a vehicle (for example, a front side of a vehicle C) that is captured or may be a video of an inside of a vehicle that is captured.

Thereby, it is possible for the management device 10 to execute analysis of a target video T or provide such a target video T to the manager terminal 200. That is, in an upload method according to an embodiment, simple information is regularly uploaded from the on-vehicle device 50 to the management device 10 and detailed information is uploaded in a case where a request is provided from the management device 10.

Therefore, in an upload method according to an embodiment, not all videos are uploaded, so that it is possible to reduce an amount of data that are uploaded.

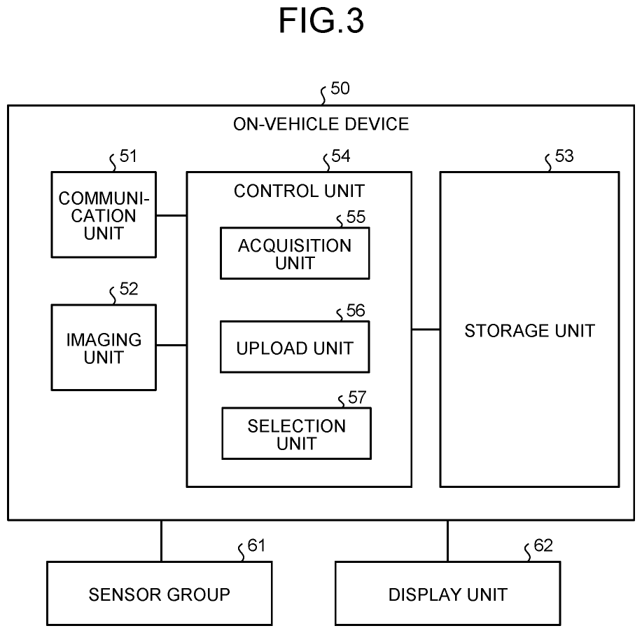

Next, a configuration example of an on-vehicle device 50 will be explained by using FIG. 3. FIG. 3 is a block diagram of the on-vehicle device 50. As illustrated in FIG. 3, the on-vehicle device 50 includes a communication unit 51, an imaging unit 52, a storage unit 53, and a control unit (a processor) 54. Furthermore, the on-vehicle device 50 is connected to a sensor group 61 and a display unit 62.

The sensor group 61 includes various types of sensors that detect, for example, a running state of a vehicle C. Such a sensor group 61 includes a vehicle speed sensor, a brake sensor, a steering angle sensor, an acceleration sensor, a position sensor, an obstacle detection sensor, etc.

The display unit 62 is a touch panel display that is mounted on a vehicle C. For example, the display unit 62 displays a video that is input from the on-vehicle device 50. Additionally, the display unit 62 may have a speaker so as to output a sound that is input from the on-vehicle device 50.

The communication unit 51 is realized by, for example, a Network Interface Card (NIC), etc. The communication unit 51 is connected to a predetermined communication network so as to be two-way-communicable and executes transmission/receipt of information, with a management device 10, etc.

The imaging unit 52 includes various types of imaging elements and captures an image of a periphery of a vehicle C. Additionally, the on-vehicle device 50 may be configured to have the imaging unit 52 that captures an image of an inside (for example, a driver) of a vehicle.

The storage unit 53 is a storage unit that is composed of a storage device such as, for example, a non-volatile memory, a data flash, and/or a hard disk drive, and stores various types of information that is input from the imaging unit 52 and the sensor group 61.

The control unit 54 includes an acquisition unit 55, an upload unit 56, and a selection unit 57, and includes a computer that has, for example, a Central Processing Unit (CPU), a Read Only Memory (ROM), a Random Access Memory (RAM), a hard disk drive, an input/output port, etc., and/or various types of circuits.

A CPU of a computer reads and executes a program that is stored in, for example, a ROM, so as to function as the acquisition unit 55, the upload unit 56, and the selection unit 57 of the control unit 54.

The acquisition unit 55 acquires vehicle information that includes image information that is captured by the imaging unit 52 and various types of driving information that is input from the sensor group 61. Furthermore, the acquisition unit 55 stores acquired vehicle information in the storage unit 53. Additionally, the acquisition unit 55 may compress image information and store it in the storage unit 53.

The upload unit 56 creates light information where data of vehicle information that is acquired by the acquisition unit 55 are lightened, and uploads it to the management device 10 with a predetermined period. Herein, light information includes running information and a still image. Herein, running information such as position information and/or vehicle speed information is so-called text data, so that an amount of data thereof is less than that of image information.

Hence, for running information that is included in light information, the upload unit 56 may upload information for all time periods, without lightened information. That is, in particular, the upload unit 56 lightens image information that causes a lack of an amount of data and uploads a still image regularly, so that it is possible to reduce an amount of data that are uploaded, efficiently.

Furthermore, the upload unit 56 receives a request from the management device 10 and uploads vehicle information that is selected by the selection unit 57 as described later to the management device 10.

The selection unit 57 selects vehicle information that is uploaded to the management device 10, based on a request from the management device 10. For example, the selection unit 57 selects vehicle information with a type and a time period that are specified, based on a request from the management device 10.

For example, the selection unit 57 selects a target video T with a specified time period (see FIG. 2) from the storage unit 53 and uploads it to the management device 10 through the upload unit 56. Additionally, the on-vehicle device 50 may upload another/other type(s) of information (for example, driving information that is not regularly uploaded) as vehicle information, as well as a video.

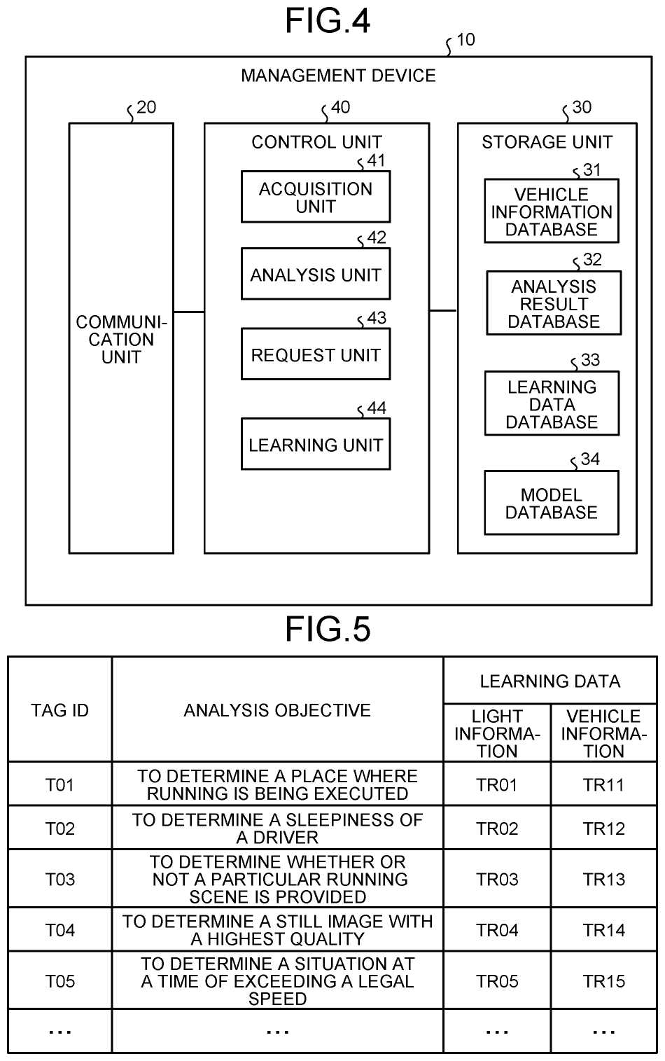

Subsequently, a configuration example of a management device 10 will be explained by using FIG. 4. As illustrated in FIG. 4, the management device 10 according to an embodiment includes a communication unit 20, a storage unit 30, and a control unit 40.

The communication unit 20 is realized by, for example, a Network Interface Card (NIC), etc. The communication unit 20 is connected to a predetermined communication network so as to be two-way-communicable and executes transmission/receipt of information, with an on-vehicle device 50, etc.

The storage unit 30 is a storage unit that is composed of a storage device such as, for example, a non-volatile memory, a data flash, and/or a hard disk drive. As illustrated in FIG. 4, the storage unit 30 has a vehicle information database 31, an analysis result database 32, a learning data database 33, and a model database 34.

The vehicle information database 31 is a database that stores light information and vehicle information that are acquired from each on-vehicle device 50. The analysis result database 32 is a database that stores an analysis result for vehicle information that is acquired from each on-vehicle device 50.

The learning data database 33 is a database concerning learning data. For example, learning data are data for learning a relationship between light information and vehicle information, from a viewpoint that what vehicle information has to be further requested in a case where what light information is uploaded from the on-vehicle device 50.

FIG. 5 is a diagram that illustrates an example of a learning data database 33. As illustrated in FIG. 5, the learning data database 33 stores information with items such as “TAG ID”, “ANALYSIS OBJECTIVE”, and “LEARNING DATA” so as to associate with one another. For example, setting of an analysis objective and tagging of learning data are executed by a manager that operates each manager terminal 200. That is, it is possible to determine what analysis objective is set, freely, and data such as what vehicle information is additionally requested from light information are stored in the learning data database 33.

“TAG ID” is an identifier for identifying a tag that tags learning data. “ANALYSIS OBJECTIVE” indicates an analysis objective of a tag that is identified by a corresponding tag ID. “LEARNING DATA” indicate a body of learning data and include, for example, light information that is uploaded periodically and vehicle information that is uploaded from an on-vehicle device 50 based on a request from a management device 10.

As illustrated in the same figure, an analysis objective of a tag ID of “T01” is “TO DETERMINE A PLACE WHERE RUNNING IS BEING EXECUTED” and is, for example, a case where a manager wishes to determine a place where a vehicle C is running, by viewing a still image of a front side of such a vehicle that is captured.

An analysis objective of a tag ID of “T02” is “TO DETERMINE A SLEEPINESS OF A DRIVER” and is, for example, a case where a manager wishes to determine a sleepiness of a driver, by viewing a still image of an inside of a vehicle that is captured. That is, a case where a still image is captured at a time when a driver is blinking is also supposed, and hence, it is a case where it is desired that a sleepiness of a driver is determined by previous and next videos.

An analysis objective of a tag ID of “T03” is “TO DETERMINE WHETHER OR NOT A PARTICULAR RUNNING SCENE IS PROVIDED”. For example, a tag ID of “T03” is utilized in a case where a preliminarily set condition is satisfied. For an example of such a condition, a case is provided where previous and next videos are acquired, based on, for example, an image that is captured at a time when a particular weather condition and/or road condition such as a tunnel at a time of rain is/are satisfied. In such a case, such a video is utilized in a case where it is collected as learning data concerning image analysis.

An analysis objective of a tag ID of “T04” is “TO DETERMINE A STILL IMAGE WITH A HIGHEST QUALITY” and aims to, for example, determine a still image with a highest quality, among a plurality of vehicles C that run in an identical time zone/place, and further, cause the on-vehicle device 50 that has captured such a still image to upload a video. That is, in such a case, the on-vehicle device 50 that is caused to upload a video is limited based on such a still image, so that it is possible to attain reduction of communication traffic, as compared with a case where all of the on-vehicle devices 50 are caused to upload a video.

An analysis objective of a tag ID of “T05” is “TO DETERMINE A SITUATION AT A TIME OF EXCEEDING A LEGAL SPEED” and aims to determine, for example, what situation exceeding legal one of a vehicle C is executed in. Additionally, exceeding a legal speed is executed while a map concerning a legal speed and position information and speed information that are included in vehicle information are checked.

An explanation for FIG. 4 will be returned to. The model database 34 is a database that stores a generated model based on learning data. Such a model is a model that has learned a relationship between light information and vehicle information such as what vehicle information is uploaded in a case where what light information is uploaded.

The control unit 40 includes an acquisition unit 41, an analysis unit 42, a request unit 43, and a learning unit 44, and includes a computer that has, for example, a Central Processing Unit (CPU), a Read Only Memory (ROM), a Random Access Memory (RAM), a hard disk drive, an input/output port, etc., and/or various types of circuits.

A CPU of a computer reads and executes a program that is stored in, for example, a ROM, so as to function as the acquisition unit 41, the analysis unit 42, the request unit 43, and the learning unit 44 of the control unit 40.

The acquisition unit 41 acquires light information of each vehicle C from each on-vehicle device 50 with a predetermined period, and further, acquires vehicle information that is uploaded from the on-vehicle device 50, based on a request that is provided by the request unit 43 as described later. The acquisition unit 41 stores acquired light information and vehicle information in the vehicle information database 31.

The analysis unit 42 analyzes light information and vehicle information that are acquired by the acquisition unit 41. For example, the analysis unit 42 analyzes a current situation of each vehicle C or a driver thereof. Furthermore, for example, the analysis unit 42 evaluates driving that is executed by a driver of each vehicle C as a part of analysis.

For example, an analysis result that is provided by the analysis unit 42 is stored in the analysis result database 32 and a manager terminal 200 (see FIG. 1) is also notified thereof.

The request unit 43 requests vehicle information from the on-vehicle device 50, based on an analysis result for light information that is provided by the analysis unit 42. For example, at an initial stage (a storage stage for learning data), the request unit 43 requests, from the on-vehicle device 50, vehicle information with an information type and a time period that are specified by the manager terminal 200 that is notified of an analysis result that is provided by the analysis unit 42.

By such processes, as sufficient learning data are obtained and a model is generated, the request unit 43 inputs light information to a model that is stored in the model database 34, so as to set vehicle information that is requested to be uploaded and request it from the on-vehicle device 50.

The learning unit 44 learns a relationship between vehicle information that is specified by a manager and light information so as to generate a model. For example, the learning unit 44 uses a predetermined machine learning technique for learning data that are stored in the learning data database 33 so as to generate a model.

That is, the learning unit 44 generates a model, so that it is possible to determine and collect needed information, based on light information that is autonomously collected from each on-vehicle device 50 by the management device 10.

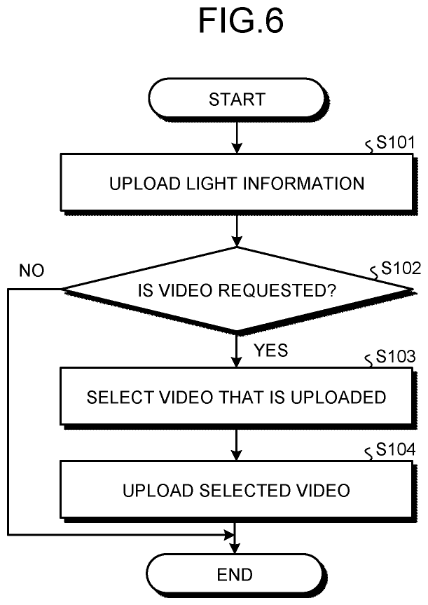

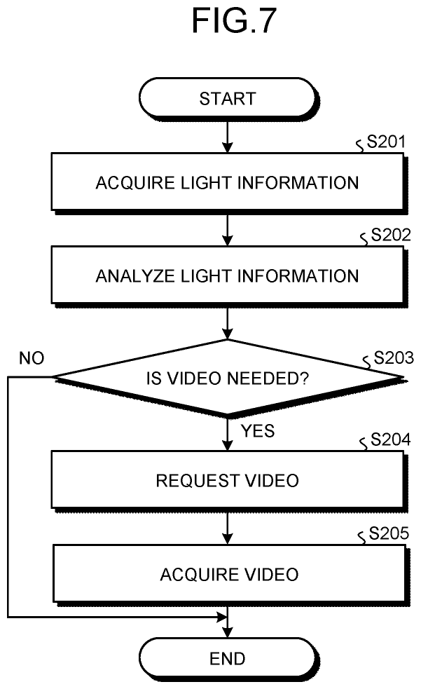

Next, process procedures that are executed by an on-vehicle device 50 and a management device 10 according to an embodiment will be explained by using FIG. 6 and FIG. 7. FIG. 6 is a flowchart that illustrates a process procedure that is executed by the on-vehicle device 50. FIG. 7 is a flowchart that illustrates a process procedure that is executed by the management device 10.

As illustrated in FIG. 6, the on-vehicle device 50 creates light information with a predetermined period and uploads created light information to the management device 10 (step S101). Subsequently, the on-vehicle device 50 determines whether or not a video request is provided from the management device 10 (step S102).

The on-vehicle device 50 moves to a process at step S103 in a case where a video request is provided (step S102; Yes) or ends a process in a case where a video request is not provided (step S102; No).

Subsequently, the on—vehicle device 50 selects a video that is uploaded, based on a video request (step S103), uploads a selected video to the management device 10 (step S104), and ends a process.

Next, a process procedure that is executed by the management device 10 will be explained by using FIG. 7. As illustrated in FIG. 7, the management device 10 acquires light information that is uploaded from each on-vehicle device 50 (step S201) and analyzes such light information (step S202).

Subsequently, the management device 10 determines whether or not a video is needed, as a result of analysis concerning light information (step S203). The management device 10 moves to a process at step S204 in a case where it is determined that a video is needed (step S203; Yes) or ends a process in a case where it is determined that a video is not needed (step S203; No).

Subsequently, the management device 10 requests a video from the on-vehicle device 50 that is provided as a target (step S204), acquires a video that is uploaded from the on-vehicle device 50 (step S205), and ends a process.

As described above, an on-vehicle device 50 according to an embodiment includes a control unit 54 (an example of a processor) that acquires vehicle information that includes running information concerning a running state of a vehicle C and image information that is captured by the vehicle C, creates light information with a less amount of data from the acquired vehicle information and uploads it to an external device with a predetermined period, and uploads the requested vehicle information to the external device in a case where a request is provided from the external device. Therefore, it is possible for an on-vehicle device 50 according to an embodiment to reduce an amount of data that are uploaded.

Additionally, although a case where the management device 10 is a server or a cloud system that aggregates driving information from each on-vehicle device 50 has been explained in an embodiment as described above, this is not limiting. A part or all of functions of the management device 10 may be provided to the on-vehicle device 50. That is, the management device 10 may be the on-vehicle device 50.

According to an aspect of an embodiment, it is possible to reduce an amount of data that are uploaded.

Appendix (1): An on-vehicle device, comprising a processor that acquires vehicle information that includes running information concerning a running state of a vehicle and image information that is captured by the vehicle, creates light information with a less amount of data from the acquired vehicle information and uploads it to an external device with a predetermined period, and uploads the requested vehicle information to the external device in a case where a request is provided from the external device.

Appendix (2): The on-vehicle device according to Appendix (1), wherein the processor uploads information with a type that is specified by the external device as the vehicle information.

Appendix (3): The on-vehicle device according to Appendix (1) or (2), wherein the processor uploads information with a time period that is specified by the external device as the vehicle information.

Appendix (4): The on-vehicle device according to Appendix (1), (2), or (3), wherein the processor uploads a still image as the light information and uploads a video with a time period that is specified by the external device as the vehicle information.

Appendix (5): The on-vehicle device according to Appendix (4), wherein the processor uploads a still image of an outside of the vehicle that is captured, as the light information, and uploads a video concerning a still image of the outside of the vehicle that is captured within a time period that is specified by the external device, as the vehicle information.

Appendix (6): The on-vehicle device according to Appendix (4) or (5), wherein the processor uploads a still image of an inside of the vehicle that is captured, as the light information, and uploads a video concerning a still image of the inside of the vehicle that is captured within a time period that is specified by the external device, as the vehicle information.

Appendix (7): The on-vehicle device according to any one of Appendices (1) to (6), wherein the running information is information concerning an output result of a sensor that is mounted on the vehicle, and the processor uploads the running information for all time periods as the light information to the external device.

Appendix (8): A management system, comprising the on-vehicle device according to any one of Appendices (1) to (7), and a management device that aggregates and manages information that is uploaded from the on-vehicle device.

Appendix (9): The management system according to Appendix (8), wherein the management device provides the light information to a manager and requests the vehicle information that is specified by the manager from the on-vehicle device.

Appendix (10): The management system according to Appendix (9), wherein the management device generates a model that has learned a relationship between the vehicle information that is specified by the manager and the light information, and requests the vehicle information from the on-vehicle device by using the model.

Appendix (11): The management system according to Appendix (8), (9), or (10), wherein the management device requests the vehicle information from the on-vehicle device in a case where the light information satisfies a preliminarily set condition.

Appendix (12): The management system according to any one of Appendices (8) to (11), wherein the management device compares the light information that is acquired by each of a plurality of the on-vehicle devices and determines the on-vehicle device where the vehicle information is requested therefrom.

Appendix (13): The management system according to any one of Appendices (8) to (12), wherein the light information includes information concerning a speed of the vehicle, and the management device requests the vehicle information in a case where a speed of the vehicle exceeds a legal speed.

Appendix (14): An upload method that is executed by a processor, wherein the upload method acquires vehicle information that includes running information concerning a running state of a vehicle and image information that is captured by the vehicle, creates light information with a less amount of data from the acquired vehicle information and uploads it to an external device with a predetermined period, and uploads the requested vehicle information to the external device in a case where a request is provided from the external device.

It is possible for a person(s) skilled in the art to readily derive an additional effect(s) and/or variation(s). Hence, a broader aspect(s) of the present invention is/are not limited to a specific detail(s) and a representative embodiment(s) as illustrated and described above. Therefore, various modifications are possible without departing from the spirit or scope of a general inventive concept that is defined by the appended claim(s) and an equivalent(s) thereof.

What is claimed is:

1. An on-vehicle device, comprising a processor configured to:
acquire vehicle information that includes running information concerning a running state of a vehicle and image information that is captured by the vehicle;
create light information with a less amount of data from the acquired vehicle information and upload the light information to an external device with a predetermined period; and
upload the requested vehicle information to the external device in a case where a request is provided from the external device.

2. The on-vehicle device according to claim 1, wherein the processor is further configured to upload information with a type that is specified by the external device as the vehicle information.

3. The on-vehicle device according to claim 1, wherein
the processor is further configured to upload information with a time period that is specified by the external device as the vehicle information.

4. The on-vehicle device according to claim 1, wherein
the processor is further configured to upload a still image as the light information and upload a video with a time period that is specified by the external device as the vehicle information.

5. The on-vehicle device according to claim 4, wherein
the processor is further configured to upload a still image of an outside of the vehicle that is captured, as the light information, and upload a video concerning a still image of the outside of the vehicle that is captured within a time period that is specified by the external device, as the vehicle information.

6. The on-vehicle device according to claim 4, wherein
the processor is further configured to upload a still image of an inside of the vehicle that is captured, as the light information, and upload a video concerning a still image of the inside of the vehicle that is captured within a time period that is specified by the external device, as the vehicle information.

7. The on-vehicle device according to claim 1, wherein:
the running information is information concerning an output result of a sensor that is mounted on the vehicle; and
the processor is further configured to upload the running information for all time periods as the light information to the external device.

8. A management system, comprising:
the on-vehicle device according to claim 1; and
a management device configured to aggregate and manage information that is uploaded from the on-vehicle device.

9. The management system according to claim 8, wherein
the management device is further configured to provide the light information to a manager and request the vehicle information that is specified by the manager from the on-vehicle device.

10. The management system according to claim 9, wherein
the management device is further configured to generate a model that has learned a relationship between the vehicle information that is specified by the manager and the light information, and request the vehicle information from the on-vehicle device by using the model.

11. The management system according to claim 8, wherein
the management device is further configured to request the vehicle information from the on-vehicle device in a case where the light information satisfies a preliminarily set condition.

12. The management system according to claim 8, wherein
the management device is further configured to compare the light information that is acquired by each of a plurality of the on-vehicle devices and determine the on-vehicle device where the vehicle information is requested therefrom.

13. The management system according to claim 8, wherein:
the light information includes information concerning a speed of the vehicle; and
the management device is further configured to request the vehicle information in a case where a speed of the vehicle exceeds a legal speed.

14. An upload method, comprising:
acquiring vehicle information that includes running information concerning a running state of a vehicle and image information that is captured by the vehicle;
creating light information with a less amount of data from the acquired vehicle information and uploading the light information to an external device with a predetermined period; and
uploading the requested vehicle information to the external device in a case where a request is provided from the external device.
